(19) United States
(12) Patent Application Publication
(10) Pub. No.: US 2010/0237282 A1
(43) Pub. Date: Sep. 23, 2010

(54) BLEACHING COMPOSITION

(76) Inventors: Yosuke Komatsu, Wakayama (JP); Shin Aihara, Wakayama (JP)

Correspondence Address: BIRCH STEWART KOLASCH & BIRCH, PO BOX 747, FALLS CHURCH, VA, 22040-0747, US

(21) Appl. No.: 12/377,981

(22) PCT Filed: Oct. 30, 2007
(86) PCT No.: PCT/JP2007/071450

§ 371 Date: Feb. 18, 2009

(30) Foreign Application Priority Data
Oct. 31, 2006 (JP) 2006-295109
Oct. 23, 2007 (JP) 2007-274667

(51) Int. Cl. C11D 3/395

(52) U.S. Cl. 252/187.25

(57) ABSTRACT

The present invention relates to a bleaching composition containing, in a specific ratio, (a) an alkali metal hypochlorite, (b) an amphoteric polymer compound having, as constituent units, (b1) a monomer unit having at least one member selected from a quaternary ammonium group, a tertiary amine group and a secondary amine group and (b2) a monomer unit having an anionic group, (c) a quaternary ammonium-based surfactant, and (d) water.

### FIELD OF THE INVENTION

The present invention relates to a bleaching composition.

### BACKGROUND OF THE INVENTION

Dirt on hard surfaces in a house is of great variety, varying depending on the surface to be cleaned. Generally, composite dirt composed of denatured oil, dust etc. will adhere easily around an electric range in a kitchen, or inorganic matter and organic matter will form insoluble salts to remain as dirt in a toilet or a bathroom or may serve as substrates on which bacteria and molds grow to generate dirt. In the dirt on hard surfaces, darkish dirt derived from such bacteria and molds is hardly completely removed with a surfactant- or abrasive-based detergent, and thus a chlorine-based bleaching detergent compounded with a hypochlorite is used.

The conventional chlorine-based bleaching detergent has exhibited a sufficient effect on darkish dirt on tiles, joints, etc., but recently, there are increasing cases where molds grow on resin portions of a silicone resin-based caulking material or of a polyvinyl chloride resin-based flexible packing material, and molds that have grown on such resin portions are hardly removed by bleaching/degradation even with the conventional bleaching detergent that has exhibited a sufficient effect on tiles and joints.

With respect to bleaching agents compounded with hypochlorites, JP-A 2002-212593 and JP-A 2002-256289 disclose, respectively, a bleaching detergent composition containing a combination of a hypochlorite and a cationic compound. JP-A 2002-161298 discloses a bleaching detergent composition containing a combination of a hypochlorite and an amphoteric polymer.

As techniques relating to treatment agents directed to an antifouling effect, JP-A 2002-060786 discloses a germicidal antifouling agent for hard surfaces, containing a polymer having quaternary ammonium group-containing monomer units and a germicidal compound having a quaternary ammonium group, and JP-A 2002-060784 discloses a detergent composition for hard surfaces, containing a polymer having quaternary ammonium group-containing monomer units and a surfactant.

### SUMMARY OF THE INVENTION

The present invention relates to a bleaching composition containing 0.5 to 5.0% by mass of (a) an alkali metal hypochlorite (referred to hereinafter as “component (a)”), 0.005 to 1% by mass of (b) an amphoteric polymer compound (referred to hereinafter as “component (b)”) having, as constituent units, (b1) a monomer unit having at least one member selected from a quaternary ammonium group, a tertiary amine group and a secondary amine group and (b2) a monomer unit having an anionic group, 0.005 to 0.5% by mass of (c) a quaternary ammonium-based surfactant (referred to hereinafter as “component (c)”), and (d) water (referred to hereinafter as “component (d)”).

The present invention also relates to a method of removing molds which contains applying the above-mentioned bleaching composition of the invention onto a resin having molds thereon, thereby removing the molds.

### DETAILED DESCRIPTION OF THE INVENTION

JP-A2002-212593, JP-A2002-256289 and JP-A 2002-161298 supra disclose that the compositions can improve bleaching performance toward molds that have grown on a silicone caulking material and a polyvinyl chloride packing material used for waterproofing a window or a joint in a bathtub in a bathroom, etc., but there is demand for a bleaching agent further having a stronger bleaching effect. JP-A 2002-060786 and JP-A 2002-060784 supra do not refer to a bleaching agent.

The present invention relates to provide a bleaching composition excellent in bleaching power, particularly a bleaching composition showing excellent bleaching power on molds that have grown on a resin portion.

According to the present invention, there can be provided a bleaching composition excellent in bleaching power, particularly a bleaching composition showing excellent bleaching power on molds that have grown on a resin portion.

<Component (a)>

The alkali metal hypochlorite as the component (a) includes sodium hypochlorite, potassium hypochlorite, etc., among which sodium hypochlorite is particularly preferable. The content of the component (a) in the bleaching detergent composition for hard surfaces of the present invention is in the range of 0.5 to 5.0% by mass, preferably 1.0 to 4.0% by mass, more preferably 2.0 to 3.0% by mass. When the content of the component (a) is higher than 0.5% by mass, sufficient bleaching power is obtained, and when the content is lower than 5.0% by mass, excellent stability is obtained.

<Component (b)>

The component (b) used in the present invention is a polymer compound containing of (b1) a monomer unit having at least one member selected from a quaternary ammonium group, a tertiary amine group and a secondary amine group (referred to hereinafter as “monomer constituent unit (b1)”) and (b2) a monomer unit having an anionic group (referred to hereinafter as “monomer constituent unit (b2)”).

The monomer constituent unit (b1) is preferably a monomer unit derived from a monomer selected from monomers represented by the following formulae (1) and (2):

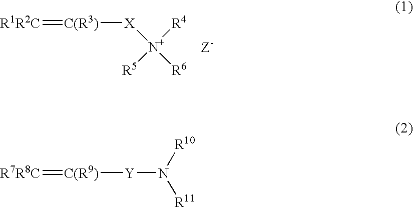

wherein R¹, R², R³, R⁷, R⁸ and R⁹ independently represent a hydrogen atom or a C1 to C3 alkyl group; X and Y independently represent a group selected from a C1 to C12 alkylene group, —COOR¹²—, —CONHR¹²—, —OCOR¹²—, and —R¹³—OCO—R¹²— provided that R¹² and R¹³ independently represent a C1 to C5 alkylene group; R⁴ represents a C1 to C3 alkyl or hydroxyalkyl group or R¹R²C═C(R³)—X—; R⁵ represents a C1 to C3 alkyl or hydroxyalkyl group; R⁶ represents a C1 to C3 alkyl or hydroxyalkyl group or a benzyl group; Z⁻ represents an anion; R¹⁰ represents a hydrogen atom, a C1 to C3 alkyl or hydroxyalkyl group or R⁷R⁸C═C(R⁹)—Y—; and R¹¹ represents a hydrogen atom, a C1 to C3 alkyl or hydroxyalkyl group.

Among the monomer constituent units (b1), the monomer unit having a quaternary ammonium group is preferably a monomer constituent unit represented by the following formula (3):

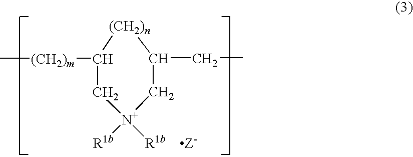

wherein R^{1b} represents a C1 to C3 alkyl or hydroxyalkyl group, each of m and n is a number of 0 or 1 provided that m+n=1, and Z⁻ is an anionic group.

In the formula (3), R^{1b} is preferably a methyl group, Z⁻ is preferably a halogen ion, a sulfate ion, a phosphate ion, a C1 to C12 fatty acid ion, or a benzene sulfonate ion optionally substituted with one to three C1 to C3 groups, more preferably a chlorine ion. n is preferably 0.

The monomer constituent unit (b2) is preferably a monomer constituent unit represented by the following formula (4):

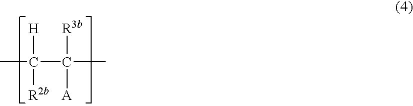

wherein R^{2b} represents a hydrogen atom, a methyl group, or —COOM, R^{3b} represents a hydrogen atom, a methyl group or a hydroxyl group, A is —COOM or -ph-SO₃M whereupon M is a hydrogen atom, an alkali metal or an alkaline earth metal, and ph is a benzene ring.

The component (b) in the present invention can be produced by subjecting monomers corresponding to the monomer constituent units constituting the component (b) to usual polymerization reaction. Alternatively, a polymer compound may be subjected to post-treatment to obtain the component (b) finally. The component (b), for example in the case of a polymer compound having a quaternary ammonium group, can be obtained either by polymerization reaction of a monomer initially having a quaternary ammonium group or polymerization reaction of a monomer having an amino group and then quaternarizing the resulting polymer. Naturally, the foregoing also applies to an anionic group. As a matter of course, the monomer used in obtaining the polymer compound requiring post-treatment is a monomer having a structure selected in consideration of the post-treatment.

Examples of the monomer represented by the formula (1) include acryloyl (or methacryloyl)aminoalkyl (C1 to C5)-N,N,N-trialkyl (C1 to C3) quaternary ammonium salt, acryloyl (or methacryloyl) oxyalkyl (C1 to C5)-N,N,N-trialkyl (C1 to C3) quaternary ammonium salt, N-(w-alkenyl (C2 to C10))-N,N,N-trialkyl (C1 to C3) quaternary ammonium salt, and N,N-di(w-alkenyl (C2 to C10))-N,N-dialkyl (C1 to C3) quaternary ammonium salt, from which the monomer unit of the formula (3) is constituted. Examples of the monomer represented by the formula (2) include acryloyl (or methacryloyl)aminoalkyl (C1 to C5)-N,N-dialkyl (C1 to C3) amine, acryloyl (or methacryloyl) oxyalkyl (C1 to C5)-N,N-dialkyl (C1 to C3) amine, N-(ω-alkenyl (C2 to C10))-N,N-dialkyl (C1 to C3) amine, N,N-di(ω-alkenyl (C2 to C10))-N-alkyl (C1 to C3) amine, allyl amine, diallyl methyl amine, and diallyl amine.

The component (b) can also be produced by polymerizing the monomer of the formula (2) and then alkylating the resulting monomer constituent unit with a quaternarizing agent such as methyl chloride, dimethyl sulfate, diethyl sulfate, ethylene oxide or propylene oxide. When ethylene oxide and/or propylene oxide is used, the monomer constituent unit should be reacted therewith after neutralization of the amino group with an acid represented by ZH (Z is a group corresponding to the above-mentioned anion Z⁻).

The monomer corresponding to the formula (4) can include acrylic acid or a salt thereof, methacrylic acid or a salt thereof, crotonic acid or a salt thereof, α-hydroxyacrylic acid or a salt thereof, maleic acid or a salt thereof, maleic anhydride, and styrene sulfonate. A monomer constituent unit obtained by polymerizing styrene sulfonate can also be obtained by polymerizing styrene, then sulfonating the resulting compound with a sulfonating agent such as sulfur trioxide, chlorosulfonic acid or sulfuric acid and neutralizing the product.

In the present invention, the monomer constituent unit having a quaternary ammonium group is preferably a monomer constituent unit obtained by polymerizing particularly N,N-diallyl-N,N-dialkyl (C1 to C3) quaternary ammonium salt, or a monomer constituent unit obtained by polymerizing N,N-diallyl-N-alkyl (C1 to C3) amine and alkylated with a quaternarizing agent such as methyl chloride, dimethylsulfuric acid, diethylsulfuric acid, ethylene oxide or propylene oxide, and the monomer constituent unit having an anionic group is preferably a monomer constituent unit obtained by polymerizing a monomer selected from acrylic acid or a salt thereof, methacrylic acid or a salt thereof, maleic acid or a salt thereof, and maleic anhydride.

In the component (b) in the present invention, the molar ratio (total number of moles of the quaternary ammonium group, tertiary amine group and secondary amine group)/(total number of moles of the anionic group) is preferably in the range of 30/70 to 95/5, more preferably 40/60 to 70/30, even more preferably 50/50 to 70/30.

The component (b) in the present invention is preferably a polymer compound wherein all of monomer constituent units (b1) and monomer constituent units (b2), preferably all of monomer units (3) represented by the formula (3) and monomer units (4) represented by the formula (4), account for 50 to 100 mol %, preferably 70 to 100 mol %, more preferably 80 to 100 mol %, even more preferably 90 to 100 mol %, based on the whole of monomer constituent units constituting the component (b). From the viewpoint of the bleaching detergent effect and storage stability, the component (b) in the present invention is preferably a polymer compound wherein all monomer constituent units (b1) having a quaternary ammonium group, a tertiary amine group and/or a secondary amine group (preferably a quaternary ammonium group) account for 30 to 90 mol %, more preferably 40 to 80 mol %, even more preferably 50 to 70 mol %, based on the whole of monomer constituent units constituting the component (b).

The composition of the present invention may contain a monomer constituent unit obtained by copolymerizing a monomer (b3) copolymerizable with the monomer constituent unit (b1) and the monomer constituent unit (b2), preferably with the monomer unit (3) represented by the formula (3) and the monomer unit (4) represented by the formula (4), to such an extent that the effect of the present invention is not impaired. Specific examples of such monomer constituent units include acrylamide, N,N-dimethylaminopropylacrylic acid (or methacrylic acid) amide, N,N-dimethylacryl (or methacryl) amide, N,N-dimethylaminoethylacrylic acid (or methacrylic acid) amide, N,N-dimethylaminomethylacrylic acid (or methacrylic acid) amide, N-vinyl-2-caprolactam, N-vinyl-2-pyrrolidone, alkyl (C1 to C5) acrylate (or methacrylate), 2-hydroxyethyl acrylate (or methacrylate), N,N-dimethylaminoalkyl (C1 to C5) acrylate (or methacrylate), vinyl acetate, ethylene, propylene, N-butylene, isobutylene, N-pentene, isoprene, 2-methyl-1-butene, N-hexene, 2-methyl-1-pentene, 3-methyl-1-pentene, 4-methyl-1-pentene, 2-ethyl-1-butene, styrene, vinyltoluene, α-methylstyrene, ethylene oxide, propylene oxide, 2-vinylpyridine, 4-vinylpyridine, and sulfur dioxide.

Particularly, a compound having sulfur dioxide copolymerized in an amount of 1 to 15 mol % in the component (b) is even more preferable.

The component (b) in the present invention can be obtained by any polymerization method, particularly preferably by a radical polymerization method, which can be carried out in a bulk, solution or emulsion system. Radical polymerization can be initiated by heating or with existing radical initiators including azo-based initiators such as 2,2′-azobis (2-amidinopropane) dihydrochloride and 2,2′-azobis (N,N-dimethyleneisobutylamidine) dihydrochloride, hydrogen peroxide, organic peroxides such as benzoyl peroxide, t-butyl hydroperoxide, cumene hydroperoxide, methyl ethyl ketone peroxide and perbenzoic acid, persulfates such as sodium persulfate, potassium persulfate and ammonium persulfate, and redox initiators such as hydrogen peroxide-Fe³⁺, or by light irradiation in the presence and/or absence of a photosensitizer or by exposure to radiation.

The weight-average molecular weight of the component (b) in the present invention is preferably 1,000 to 6,000,000, more preferably 5,000 to 3,000,000, even more preferably 10,000 to 2,000,000. This weight-average molecular weight is determined by gel permeation chromatography with a mixed solvent (phosphate buffer solution) of acetonitrile and water as a developing solvent with polyethylene glycol as standard.

The content of the component (b) in the composition is preferably 0.005 to 1% by mass, more preferably 0.005 to 0.2% by mass, more preferably 0.008 to 0.18% by mass, even more preferably 0.01 to 0.15% by mass.

<Component (c)>

The quaternary ammonium-based surfactant as the component (c) is preferably a surfactant having one alkyl group containing 6 to 18 carbon atoms, more preferably 6 to 12 carbon atoms, and preferably having a chlorine ion as a counter anion. The component (c) is represented more preferably by the following formula (5):

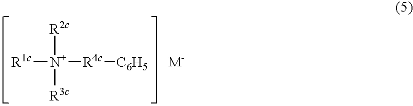

wherein R^{1c} represents an alkyl group containing preferably 6 to 18 carbon atoms, more preferably 6 to 12 carbon atoms, R^{2c} and R^{3c} independently represent a methyl or ethyl group, R^{4c} represents an alkylene group containing 1 to 3 carbon atoms, and M⁻ represents a halogen ion, an alkyl sulfate ion containing 1 to 3 carbon atoms, or a benzene sulfonate ion substituted with an alkyl group containing 1 to 3 carbon atoms.

The component (c), particularly the quaternary ammonium-based surfactant represented by the formula (5), is to improve the bleaching detergent effect on dirt on a resin material attributable to bacteria and molds, which is insufficient with the conventional chlorine-based detergent, and it is estimated that the quaternary ammonium-based surfactant assists in bringing a hypochlorite ion into contact with a hydrophobic material, thereby improving the bleaching detergent effect on dirt.

The present invention provides a bleaching composition effective for a resinous material. When the intended resin is a vinyl chloride-based resin used in, for example, a packing material in a window frame, the compound of the formula (5) wherein R^{1c} is an alkyl group having 8 carbon atoms is more effective.

The component (c) is contained in an amount of 0.005 to 0.5% by mass, preferably 0.008 to 0.3% by mass, more preferably 0.01 to 0.2% by mass, in the bleaching composition of the present invention. When the amount of the component (c) is in this range, the composition is effective in storage stability and in removal of dirt on a resinous material.

In the bleaching composition of the present invention, the mass ratio of the component (c) to the component (b), that is, (c)/(b), is preferably in the range of 0.10 to 7.0, more preferably 0.28 to 5.0, from the viewpoint of the bleaching detergent effect.

### <Other Components>

The bleaching composition of the present invention can contain an alkali metal chloride (referred to hereinafter as component (e)). The alkali metal chloride includes sodium chloride and potassium chloride, and may be contained in a solution of the alkali metal hypochlorite. The content of the component (e) in the bleaching detergent composition of the present invention is preferably 0.001 to 3.0% by mass, more preferably 0.001 to 1.0% by mass, from the viewpoint of storage stability. The concentration of the alkali metal chloride in a solution of the alkali metal hypochlorite can be reduced to such concentration for example by cooling the aqueous solution of the alkali metal hypochlorite to crystallize the alkali metal chloride, and then filtering the solution.

The bleaching composition of the present invention can contain an alkali metal hydroxide (referred to hereinafter as component (f)). The alkali metal hydroxide as the component (f) refers to the one in the form of a free alkali, that is, a combination of an alkali metal ion and a hydroxy ion in the bleaching composition, and therefore the amount of the alkali metal hydroxide combined with another counterion is not counted. For example, when an organic acid is separately compounded, the alkali metal hydroxide incorporated serves as a counterion of the organic acid, and thus the amount of this alkali metal hydroxide in the composition is not counted. The alkali metal hydroxide includes sodium hydroxide, potassium hydroxide etc., among which sodium hydroxide is preferable. Generally, an alkali metal hydroxide is incorporated in a larger amount into the chlorine-based bleaching agent or the like in order to attain the stability of hypochlorite. In the present invention, however, the content of the component (f) in the composition is preferably 0.2 to 3.0% by mass, more preferably 0.2 to 1.0% by mass, even more preferably 0.3 to 0.8% by mass, in order to attain a sufficient effect particularly on dirt attributable to molds adhering to a resinous material. When the content of the component (f) is 0.2% by mass or more, the stability of the alkali metal hypochlorite as the component (a) is made excellent with sufficient sualkalinity. When the content is 3.0% by mass or less, a sufficient effect on mold dirt on a resin can be achieved at an appropriate speed of bleaching, in addition to the stability of the alkali metal hypochlorite as the component (a). In the present invention, the amount of the component (f) in the composition is measured by a method described in ASTM D 2022-89. In this method, a free alkali in a bleaching agent is quantified as sodium hydroxide (NaOH), and in the present invention, the amount of the free alkali in the composition, as determined by this method, is regarded as the amount of the component (f) in the composition.

In the present invention, a surfactant other than the component (c) may be used, and the total amount of the component (c) and such other surfactant is desirably 5.0% by mass or less, preferably 3.0% by mass or less, more preferably 1.0% by mass or less, from the viewpoint of storage stability. The surfactant that can be used in the present invention is preferably a surfactant having an alkyl group containing 6 to 22 carbon atoms, and specific examples can include one or more members selected from nonionic surfactants (excluding nitrogen-containing anionic surfactants such as amino acid derivatives) such as alkyl sulfonates, alkane sulfonates, alkyl sulfates, alkylbenzene sulfonates, alkylnaphthalene sulfonates, alkyl sulfosuccinates, alkyl diphenyl ether disulfonates, alkyl phosphates, polyoxyethylene alkyl sulfates, polyoxyethylene alkyl aryl sulfates and polyoxyethylene alkyl phenyl ether sulfonates, and amphoteric surfactants such as alkylamine oxides, carboxybetaine and sulfobetaine. Particularly in spraying by a trigger spray, the surfactant is preferably amine oxide from the viewpoint of formation of excellent foams. Among the surfactants described above, anionic surfactants, particularly alkyl sulfonates and alkyl sulfates, will bind electrically to cationic surfactants in the detergent solution and are thus considered to function in inhibiting the synergistic effect of the hypochlorite ion (component (a)) and the cationic surfactant (component (c)) in the present invention, so the tendency for the bleaching effect to decrease was observed. With respect to the alkyl sulfonate and alkyl sulfate, therefore, the molar ratio of the cationic surfactant [including the component (c)] to (alkyl sulfonate and/or alkyl sulfate) in the composition is preferably 0.2 or more, more preferably 0.5 or more, even more preferably 1 or more.

The bleaching composition of the present invention is compounded with a hydrotropic agent selected from benzenesulfonic acid substituted with one to three C1 to C3 alkyl groups and salts thereof, thereby increasing storage stability. As another arbitrary component, a perform component can be incorporated. For examples of perfume components compounded with the hypochlorite, JP-A 50-74581 and JP-A 62-205200 can be referred to, and a single perfume or a blend of perfumes may be used. Although the perfume is contained usually in an amount of 0.001 to 0.5% by mass in the composition, the amount of the perfume incorporated should be carefully determined because stability may be impaired in some cases upon addition of the perfume.

The remainder of the composition of the present invention is water (component (d)), which from the viewpoint of storage stability, is preferably deionized water or distilled water from which metal ions etc. occurring in trace amounts were removed. The content of water in the composition is preferably 80 to 98% by mass, more preferably 90 to 98% by mass, from the viewpoint of storage stability. The pH of the composition at 20° C. is regulated preferably in the range of 12.5 to 13.5, from the viewpoint of storage stability and bleaching effect.

The viscosity of the composition of the present invention is preferably lower from the viewpoint of spraying via a trigger, and the viscosity of the composition at 20° C. is preferably 1 to 20 mPa·s, even more preferably 1 to 10 mPa·s.

Preferable methods of using the bleaching composition of the present invention include (1) a method of directly spraying onto an objective material by a sprayer such as a trigger, (2) a method of impregnating a water-absorbing pliable material with the composition and rubbing an objective material therewith, and (3) a method of dipping an objective material in a solution containing the composition dissolved therein, among which the method (1) is particularly preferable from the viewpoint of convenience. The sprayer is preferably a trigger spray capable of spraying, in foams, the bleaching composition compounded with the components (a) to (d) and arbitrary components, and the composition is sprayed preferably in amount of 5 to 15 g per m² of an objective material. The bleaching composition of the present invention can be applied by the methods (1) to (3) for example onto a resin having molds thereon, thereby removing the molds on the resin. The intended resin includes various resins such as silicone-based resin and vinyl chloride-based resin used in a bathroom, a toilet and a kitchen. The bleaching composition of the present invention is suitable for hard surfaces.

### EXAMPLES

The present invention is described by reference to the Examples, but the Examples are set forth for merely illustrative purposes and not intended to limit the scope of the present invention.

### <Bleaching Power>

Molds were developed under actual use conditions on a flexible polyvinyl chloride resin packing material used in a window frame in a bathroom at house, and a test specimen was obtained therefrom and cut into about 1-cm pieces as evaluation samples. The evaluation samples were measured for their luminosity (L value) with a color measuring colorimeter (ND-300A manufactured by Nippon Denshoku Industries Co., Ltd.), and samples different in L value by ±2 or less were used. Two sheets of Kimwipes (3 cm×3 cm, manufactured by Kimberly-Clark Company) were placed on each of the test specimens, 0.5 ml of a liquid bleaching composition shown in Table 1 and 2 was dropped onto it and left for 10 minutes, then the specimen was washed with water, air-dried and measured for its luminosity (L value) with the above color measuring colorimeter. The difference in L value before and after evaluation was regarded as bleaching power. A larger difference in L value is indicative of a higher bleaching effect. The results are shown in Tables 1 and 2. The (c)/(b) ratio by mass wherein (b) represents the polymer b′ is shown for some comparative examples.

### <Storage Stability>

Some of the compositions in Tables 1 and 2 were stored at 50° C. for 2 weeks, and the storage stability of sodium hypochlorite after storage was evaluated in terms of residual ratio of available chlorine. The residual ratio of available chlorine was determined according to the following equation:

the residual ratio of available chlorine(%)=(concentration of available chlorine in the composition after storage)/(concentration of available chlorine in the composition before storage)×100.

TABLE 1

| | | | | Examples | | | | | | | | |
|---|---|---|---|---|---|---|---|---|---|---|---|---|
| | | | | 1 | 2 | 3 | 4 | 5 | 6 | 7 | 8 | 9 |
| Liquid | Compounded | (a) | Sodium hypochlorite | 2.8 | 2.8 | 2.8 | 2.8 | 2.8 | 2.8 | 2.8 | 2.8 | 2.8 |
| bleaching | components | (b) | Polymer b1 | 0.01 | 0.03 | 0.04 | 0.07 | | | | | 0.03 |
| composition | (mass %) | | Polymer b2 | | | | | 0.01 | 0.03 | 0.035 | 0.07 | |

| Polymer b′ | | | | | | | | | | |
|---|---|---|---|---|---|---|---|---|---|---|
| (c) | Surfactant c1 | 0.05 | 0.05 | 0.05 | 0.05 | 0.05 | 0.05 | 0.05 | 0.05 | 0.01 |
| (e) | NaCl | 0.45 | 0.45 | 0.45 | 0.45 | 0.45 | 0.45 | 0.45 | 0.45 | 0.45 |
| (f) | NaOH | 0.5 | 0.5 | 0.5 | 0.5 | 0.5 | 0.5 | 0.5 | 0.5 | 0.5 |
| (d) | Water | Balance | Balance | Balance | Balance | Balance | Balance | Balance | Balance | Balance |

| | | | | | | | | | |
|---|---|---|---|---|---|---|---|---|---|
| Total | 100 | 100 | 100 | 100 | 100 | 100 | 100 | 100 | 100 |

| | | | | | | | | | |
|---|---|---|---|---|---|---|---|---|---|
| pH (20° C.) | 13 | 13 | 13 | 13 | 13 | 13 | 13 | 13 | 13 |
| (c)/(b) ratio by mass | 5 | 1.7 | 1.3 | 0.71 | 5 | 1.7 | 1.4 | 0.71 | 0.33 |

| | | | | | | | | | |
|---|---|---|---|---|---|---|---|---|---|
| Bleaching power | 3.8 | 4.9 | 4.5 | 3.8 | 4 | 4.9 | 5.5 | 4.3 | 4 |

| | | | | Example | | | | | | |
|---|---|---|---|---|---|---|---|---|---|---|
| | | | | 10 | 11 | 12 | 13 | 14 | 15 | 16 |
| Liquid | Compounded | (a) | Sodium hypochlorite | 2.8 | 2.8 | 2.8 | 2.8 | 2.8 | 2.8 | 2.8 |
| bleaching | components | (b) | Polymer b1 | 0.03 | 0.03 | 0.03 | 0.03 | 0.015 | 0.06 | 0.12 |
| composition | (mass %) | | Polymer b2 | | | | | | | |

| Polymer b′ | | | | | | | | |
|---|---|---|---|---|---|---|---|---|
| (c) | Surfactant c1 | 0.03 | 0.04 | 0.07 | 0.1 | 0.01 | 0.1 | 0.4 |
| (e) | NaCl | 0.45 | 0.45 | 0.45 | 0.45 | 0.45 | 0.45 | 0.45 |
| (f) | NaOH | 0.5 | 0.5 | 0.5 | 0.5 | 0.5 | 0.5 | 0.5 |
| (d) | Water | Balance | Balance | Balance | Balance | Balance | Balance | Balance |

| | | | | | | | |
|---|---|---|---|---|---|---|---|
| Total | 100 | 100 | 100 | 100 | 100 | 100 | 100 |

| | | | | | | | |
|---|---|---|---|---|---|---|---|
| pH (20° C.) | 13 | 13 | 13 | 13 | 13 | 13 | 13 |
| (c)/(b) ratio by mass | 1 | 1.3 | 2.3 | 3.3 | 0.8 | 1.7 | 3.3 |

| | | | | | | | |
|---|---|---|---|---|---|---|---|
| Bleaching power | 4.6 | 5 | 4.5 | 3.5 | 3.6 | 6.3 | 6.6 |

TABLE 2

| | | | | Examples | | | | | | | | |
|---|---|---|---|---|---|---|---|---|---|---|---|---|
| | | | | 17 | 18 | 19 | 20 | 21 | 22 | 23 | 24 | 25 |
| Liquid bleaching | Compounded | (a) | Sodium hypochlorite | 2.8 | 2.8 | 2.8 | 2.8 | 2.8 | 2.8 | 2.8 | 2.8 | 2.8 |
| composition | components | (b) | Polymer b1 | | | | | | | | | |
| | (mass %) | | Polymer b2 | 0.035 | 0.035 | 0.035 | 0.035 | 0.018 | 0.07 | 0.14 | | |
| | | | Polymer b3 | | | | | | | | 0.03 | |
| | | | Polymer b4 | | | | | | | | | 0.03 |

| Polymer b′ | | | | | | | | | | |
|---|---|---|---|---|---|---|---|---|---|---|
| (c) | Surfactant c1 | 0.02 | 0.03 | 0.04 | 0.07 | 0.025 | 0.1 | 0.2 | 0.05 | 0.05 |
| (e) | NaCl | 0.45 | 0.45 | 0.45 | 0.45 | 0.45 | 0.45 | 0.45 | 0.45 | 0.45 |
| (f) | NaOH | 0.5 | 0.5 | 0.5 | 0.5 | 0.5 | 0.5 | 0.5 | 0.5 | 0.5 |
| (d) | Water | Balance | Balance | Balance | Balance | Balance | Balance | Balance | Balance | Balance |

| | | | | | | | | | |
|---|---|---|---|---|---|---|---|---|---|
| Total | 100 | 100 | 100 | 100 | 100 | 100 | 100 | 100 | 100 |

| | | | | | | | | | |
|---|---|---|---|---|---|---|---|---|---|
| pH (20° C.) | 13 | 13 | 13 | 13 | 13 | 13 | 13 | 13 | 13 |
| (c)/(b) ratio by mass | 0.57 | 0.86 | 1.1 | 2 | 1.4 | 1.4 | 1.4 | 1.7 | 1.7 |

| Bleaching power | | | | | | 4 | 5.1 | 4.2 | 3.6 | 4.1 | 5.6 | 5.6 | 4.2 | 4.8 |
|---|---|---|---|---|---|---|---|---|---|---|---|---|---|---|
| | | | | Comparative examples | | | | | | | | | | |
| | | | | 1 | 2 | 3 | 4 | 5 | 6 | 7 | 8 | 9 | 10 | 11 |
| Liquid | Compounded | (a) | Sodium | 2.8 | 2.8 | 2.8 | 2.8 | 2.8 | 2.8 | 2.8 | 2.8 | 2.8 | 2.8 | 2.8 |
| bleaching | components | | hypochlorite | | | | | | | | | | | |
| compo- | (mass %) | (b) | Polymer b1 | | | 0.03 | | 0.003 | | | 0.003 | | | |
| sition | | | Polymer b2 | | | | 0.035 | | 0.003 | | | 0.003 | 0.001 | 3 |
| | | | Polymer b3 | | | | | | | | | | | |
| | | | Polymer b4 | | | | | | | | | | | |

| | Polymer b′ | 0.03 | | | | | | | | | | |
|---|---|---|---|---|---|---|---|---|---|---|---|---|
| (c) | Surfactant c1 | 0.05 | 0.05 | | | 0.013 | 0.013 | | 0.05 | 0.05 | 0.01 | 0.15 |
| (e) | NaCl | 0.45 | 0.45 | 0.45 | 0.45 | 0.45 | 0.45 | 0.45 | 0.45 | 0.45 | 0.45 | 0.45 |
| (f) | NaOH | 0.5 | 0.5 | 0.5 | 0.5 | 0.5 | 0.5 | 0.5 | 0.5 | 0.5 | 0.5 | 0.5 |
| (d) | Water | Balance | Balance | Balance | Balance | Balance | Balance | Balance | Balance | Balance | Balance | Balance |

| | | | | | | | | | | | |
|---|---|---|---|---|---|---|---|---|---|---|---|
| Total | 100 | 100 | 100 | 100 | 100 | 100 | 100 | 100 | 100 | 100 | 100 |

| | | | | | | | | | | | |
|---|---|---|---|---|---|---|---|---|---|---|---|
| pH (20° C.) | 13 | 13 | 13 | 13 | 13 | 13 | 13 | 13 | 13 | 13 | 13 |
| (c)/(b) ratio by mass | 1.7 | — | 0 | 0 | 4.3 | 4.3 | — | 17 | 17 | 10 | 0.05 |

| | | | | | | | | | | | |
|---|---|---|---|---|---|---|---|---|---|---|---|
| Bleaching power | 3.1 | 3 | 2.2 | 2.2 | 2.4 | 2.6 | 2.1 | 3.1 | 3.1 | 2.4 | 3.1 |

Note: Ingredients in the Tables are as follows.

Polymer b1: Merquat 280 manufactured by Calgon (copolymer of diallyldimethylammonium chloride and acrylic acid, diallyldimethylammonium chloride/acrylic acid=8/2 (ratio by weight), a weight-average molecular weight of 1,700,000)

Polymer b2: Copolymer of diallyldimethylammonium chloride, maleic acid and sulfur dioxide (diallyldimethylammonium chloride/maleic acid/sulfur dioxide=100/40/10 (molar ratio), a weight-average molecular weight of 20,000)

Polymer b3: Copolymer of dimethylaminoethyl methacrylate chloride and acrylic acid (dimethylaminoethyl methacrylate chloride/acrylic acid=1/1 (molar ratio), a weight-average molecular weight of 450,000)

Polymer b4: Copolymer of diallylamine hydrochloride and maleic acid (diallylamine hydrochloride/maleic acid=1/1 (molar ratio), a weight-average molecular weight of 20,000)

Polymer b′: Merquat 100 manufactured by Calgon (diallyldimethylammonium homopolymer, a weight-average molecular weight of 400,000)

Surfactant c1: Octyldimethylbenzylammonium chloride

TABLE 3

| | | | | | | Comparative | |
|---|---|---|---|---|---|---|---|
| | | | | Example | | example | |
| | | | | 2 | 6 | 1 | 2 |
| Liquid | Compounded | (a) | Sodium hypochlorite | 2.8 | 2.8 | 2.8 | 2.8 |
| bleaching | components | (b) | Polymer b1 | 0.03 | | | |
| composition | (mass %) | | Polymer b2 | | 0.03 | | |

| Polymer b′ | | | | 0.03 | |
|---|---|---|---|---|---|
| (c) | Surfactant c1 | 0.05 | 0.05 | 0.05 | 0.05 |
| (e) | NaCl | 0.45 | 0.45 | 0.45 | 0.45 |
| (f) | NaOH | 0.5 | 0.5 | 0.5 | 0.5 |
| (d) | Water | Balance | Balance | Balance | Balance |

| | | | | |
|---|---|---|---|---|
| Total | 100 | 100 | 100 | 100 |

| | | | | |
|---|---|---|---|---|
| pH (20° C.) | 13 | 13 | 13 | 13 |
| (c)/(b) ratio by mass | 1.7 | 1.7 | 1.7 | — |

| | | | | |
|---|---|---|---|---|
| Bleaching power | 4.9 | 4.9 | 3.1 | 3 |
| Residual ratio of available chlorine (%) | 77 | 85 | 77 | 95 |

1. A bleaching composition comprising 0.5 to 5.0% by mass of (a) an alkali metal hypochlorite, 0.005 to 1% by mass of (b) an amphoteric polymer compound having, as constituent units, (b1) a monomer unit having at least one member selected from the group consisting of a quaternary ammonium group, a tertiary amine group and a secondary amine group and (b2) a monomer unit having an anionic group, 0.005 to 0.5% by mass of (c) a quaternary ammonium-based surfactant, and (d) water.

2. The bleaching composition according to claim 1, wherein (b) has a monomer unit derived from a monomer selected from the group consisting of monomers represented by the following formula (1) and monomers represented by the following formula (2): 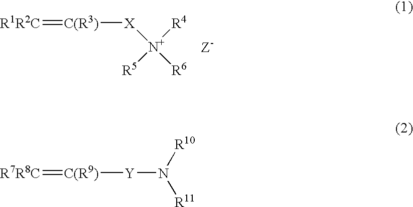
wherein R¹, R², R³, R⁷, R⁸ and R⁹ independently represent a hydrogen atom or a C1 to C3 alkyl group; X and Y independently represent a group selected from the group consisting of a C1 to C12 alkylene group, —COOR¹²—, —CONHR'²—, —OCOR¹²—, and —R¹³—OCO—R¹²—, provided that R¹² and R¹³ independently represent a C1 to C5 alkylene group; R⁴ represents a C1 to C3 alkyl or hydroxyalkyl group or R¹R²C═C(R³)—X—; R⁵ represents a C1 to C3 alkyl or hydroxyalkyl group; R⁶ represents a C1 to C3 alkyl or hydroxyalkyl group or a benzyl group; Z⁻ represents an anion; R¹⁰ represents a hydrogen atom, a C1 to C3 alkyl or hydroxyalkyl group or R⁷R⁸C═C(R⁹)—Y—; and R¹¹ represents a hydrogen atom, a C1 to C3 alkyl or hydroxyalkyl group.

3. The bleaching composition according to claim 1 or 2, wherein (b) is a copolymer containing, in an amount of 50 mol % to 100 mol % in the whole of monomer units, a monomer unit (3) represented by the following formula (3) and a monomer unit (4) represented by the following formula (4): 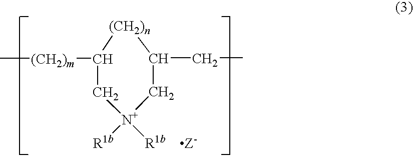
wherein R^{1b} represents a C1 to C3 alkyl or hydroxyalkyl group, each of in and n is a number of 0 or 1 provided that m+n=1, and Z⁻ is an anionic group, and 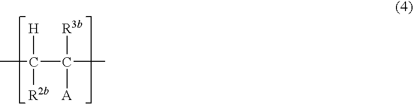
wherein R^{2b} represents a hydrogen atom, a methyl group, or —COOM, R^{3b} represents a hydrogen atom, a methyl group or a hydroxyl group, A is —COOM or -ph-SO₃M whereupon M is a hydrogen atom, an alkali metal or an alkaline earth metal, and ph is a benzene ring.

4. The bleaching composition according to claim 1 or 2, wherein (c) is a quaternary ammonium-based surfactant represented by the following formula (5): 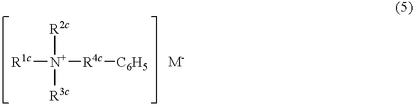
wherein R^{1c} represents a C6 to C18 alkyl group, R^{2c} and R^{3c} independently represent a methyl or ethyl group, R^{4c} represents a C1 to C3 alkylene group, and M⁻ represents a halogen ion, a C1 to C3 alkyl sulfate ion, or a benzene sulfonate ion substituted with a C1 to C3 alkyl group.

5. The bleaching composition according to claim 1 or 2, wherein the mass ratio of (c) to (b), that is, (c)/(b), is from 0.10 to 7.0.

6. A method of removing molds which comprises applying the bleaching composition of claim 1 or 2 onto a resin having molds thereon, thereby removing the molds.
